(19) United States
(12) Patent Application Publication
(10) Pub. No.: US 2016/0170531 A1
(43) Pub. Date: Jun. 16, 2016

(54) TOUCH SIGNAL DETECTION APPARATUS AND TOUCH SIGNAL DETECTION METHOD

(71) Applicant: G2TOUCH Co., LTD, Seongnam (KR)

(72) Inventor: Sung Ho LEE, Hwaseong (KR)

(21) Appl. No.: 14/964,293

(22) Filed: Dec. 9, 2015

(30) Foreign Application Priority Data
Dec. 10, 2014 (KR) 10-2014-0177763

(51) Int. Cl. G06F 3/044; G06F 3/041

(52) U.S. Cl. CPC G06F 3/044; G06F 3/0418; G06F 3/0412; G06F 2203/04104

(57) ABSTRACT

Disclosed herein is a capacitive touch input apparatus of a human finger or a touch input means having conductive characteristics similar thereto, and more particularly, a touch signal detection apparatus and a touch signal detection method capable of improving a touch detection resolution by minimizing or excluding a signal interference between touch detection signals upon detecting touch signals. According to the touch signal detection apparatus and the touch signal detection method according to the present invention, it is possible to improve a touch detection resolution by removing an interference between the touch signals even in the case of a multi touch. According to the touch signal detection apparatus and the touch signal detection method according to the present invention, it is possible to easily detect the touch signals and minimize the effect on a display device to maximize a display quality of the display device.

### CROSS-REFERENCE TO RELATED APPLICATIONS

This application claims priority from and the benefit of Korean Patent Application No. 10-2014-0177763, filed on Dec. 10, 2014, which is hereby incorporated by reference for all purposes as if fully set forth herein.

### BACKGROUND OF THE INVENTION

1. Field of the Invention

The present invention relates to a capacitive touch input apparatus of a human finger or a touch input means having conductive characteristics similar thereto, and more particularly, to a touch signal detection apparatus and a touch signal detection method capable of improving a touch detection resolution by minimizing or excluding a signal interference between touch detection signals upon detecting touch signals.

2. Discussion of the Background

Generally, a touch screen panel is attached on display devices such as a liquid crystal display (LCD), a plasma display panel (PDP), and an organic light emitting diode (OLED), an active matrix organic light emitting diode (AMOLED) and is one of the input apparatuses that generate signals corresponding to positions where objects such as a finger and a pen are touched. The touch screen panel has been used in wide applications such as small portable terminals, industrial terminals, and digital information devices (DIDs).

Typically, various types of touch screen panels have been disclosed. However, a resistive touch screen panel having simple manufacturing process and low manufacturing costs has been most widely used. However, the resistive touch screen panel has the low transmissivity and needs to be applied with a pressure, For this reason, the resistive touch screen panel is inconvenient to use, has a difficulty in implementing a multi touch and a gesture cognition, leads to a detection error, etc.

On the other hand, a capacitive touch screen panel may have high transmissivity, cognize a soft touch, and implement better multi touch and gesture cognition. As a result, the capacitive touch screen panel is gradually expanding into new markets.

FIG. 1 illustrates an example of the existing capacitive touch screen panel. Referring to FIG. 1, transparent conductive layers are formed on upper and lower surfaces of a transparent substrate 2 made of plastic, glass, etc., and voltage applying metal electrodes 4 are formed at each of the four corners of the transparent substrate 2. The transparent conductive layer is made of transparent metals such as indium tin oxide (ITO) and antimony tin oxide (ATO). Further, the metal electrodes 4 formed at four corners of the transparent conductive layer are formed by being printed with conductive metal having low resistivity such as silver Ag. A resistance network is formed around the metal electrodes 4. The resistance network is formed in a linearization pattern to equally send out a control signal to the whole surface of the transparent conductive layer. Further, an upper portion of the transparent conductive layer including the metal electrode 4 is coated with a passivation layer.

In the capacitive touch screen panel as described above, a high-frequency alternating voltage is applied to the metal electrode 4 and thus is conducted over the whole surface of the transparent substrate 2. In this case, when the transparent conductive layer on an upper surface of the transparent substrate 2 is light touched with a finger 8 or a conductive touch input means, a change in current is sensed by a current sensor embedded in a controller 6 while a predetermined amount of current is absorbed into a body and current amounts at each of the four metal electrodes 4 are calculated, thereby cognizing touched points.

However, the capacitive touch screen panel as illustrated in FIG. 1 is based on a method for detecting a magnitude of micro current. As a result, the capacitive touch screen panel needs an expensive detection apparatus and therefore a price of the capacitive touch screen panel goes up and it is difficult for capacitive touch screen panel to implement a multi touch for cognizing a plurality of touches.

To overcome the above problems, the capacitive touch screen panel as illustrated in FIG. 2 has been mainly used in recent years. The touch screen panel of FIG. 2 is configured to include a lateral linear touch pad 5a, a longitudinal linear touch pad 5b, and a touch drive IC 7 analyzing a touch signal. The touch screen panel is based on a method for detecting a magnitude of capacitance formed between the linear touch pad 5 and the finger 8 and scans the lateral linear touch pad 5a and the longitudinal linear touch pad 5b to detect a signal, thereby cognizing the plurality of touched points.

However, when the above-mentioned touch screen panel is installed on a display device such as an LCD, it is difficult for the touch screen panel to detect a signal due to noise. For example, the LCD uses a common electrode applied with a common voltage Vcom that is commonly applied to a liquid crystal. In this case, the common voltage is affected by a pixel voltage applied to the liquid crystal and therefore may be fluctuated. As a result, the common voltage Vcom of the common electrode acts as noise upon detecting the touched point.

Further, unlike the effect of the fluctuation of the common voltage on the touch signal, a scan signal may affect the common voltage upon scanning the lateral linear touch pad 5a and the longitudinal linear touch pad 5b to acquire touch signals to cause deterioration in image quality.

FIG. 3 illustrates an embodiment in which the existing capacitive touch screen panel is installed on the LCD. A display device 200 has a structure in which a liquid crystal is sealed between a TFT substrate 205 at a lower portion thereof and a color filter 215 at an upper portion thereof to form a liquid crystal layer 210. To seal the liquid crystal, the TFT substrate 205 and the color filter 215 are bonded to each other by having a sealant 230 disposed at outer portions thereof. Although not illustrated, polarizing plates are attached to upper and lower portions of a liquid crystal panel and back light units (BLUs) are additionally installed at the liquid crystal panel.

As illustrated, the touch screen panel is installed at the upper portion of the display device 200. The touch screen panel has a structure in which the linear touch pad 5 is put on an upper surface of the substrate 1. A protection panel 3 for protecting the linear touch pad 5 is attached on the substrate 1. The touch screen panel is bonded to an edge portion of the display device 200 by an adhesive member 9 such as a double adhesive tape (DAT), in which an air gap 9a is formed between the touch screen panel and the display device 200.

In this configuration, when a touch is performed as illustrated in FIG. 3, a capacitance such as Ct is formed between the finger 8 and the linear touch pad 5. However, as illustrated, a capacitance such as common electrode capacitance Cvcom is also formed between the linear touch pad 5 and the common electrode 200 formed on a lower surface of the color filter 215 of the display device 200 and an unknown parasitic capacitance Cp that occurs due to a capacitance coupling between patterns, manufacturing process factors, etc., is also applied to the linear touch pad 5. Therefore, a circuit like an equivalent circuit of FIG. 4 is configured.

Here, the existing touch screen panel detects a variation of Ct that is a touch capacitance to cognize a touch and components such as Cvcom and Cp act as noise upon detecting the Ct. In particular, the common electrode capacitance Cvcom may also be ten times larger than the Ct that is the touch capacitance. As a result, there is a problem in that touch sensitivity may be reduced due to a distortion of the touch signals due to the fluctuation of the Cvcom and the touch capacitance ten times larger than the Ct.

To solve the above problem, a touch signal detection method with a new structure to reduce the Cvcom has been proposed. FIG. 5 illustrates an embodiment of a method for reducing Cvcom. The method for reducing Cvcom separates the linear sensor of FIG. 2 into several to reduce the Cvcom, thereby solving problems such as the reduction in sensitivity or the effect on the display device. However, in the structure, since the number of touch pads 10 is more than the number of linear sensors 5 of FIG. 2, the plurality of touch pads 10 need to detect the touch signals to meet a touch signal report time. In this case, upon simultaneously detecting the touch signals in row signals (for example, (Col1, Row1) and (Col1, Row2)) adjacent to the same column, the interference of the touch signals may occur due to the parasitic capacitance Cp between sensor signal lines 22 connected to each of the touch pads 10.

FIG. 6 illustrates an embodiment in which the interference of the touch signals occurs upon simultaneously detecting the touch signals in (C1, R1) 22-a and (C1, R2) 22-b. Referring to FIGS. 5 and 6, a sensing pad signal line 22a of FIG. 6 which is adjacent to the signal line 22b in FIG. 5 is connected to a touch drive IC (TDI) and the parasitic capacitance Cp is formed between the signal line 22a and the signal line 22b. Upon detecting the touch signals by the (C1, R1) touch pad of FIG. 6 using a driving back phenomenon (see Patent Application No. 2012-0109309), the (C1, R1) and the (C1, R2) may be affected to each other due to the parasitic capacitance Cp and therefore an error of the touch signal detection occurs.

### RELATED ART DOCUMENT

### Patent Document

(Patent Document 1) Patent Application No. 2012-0109309

(Patent Document 2) Title: Touch signal detection apparatus using driving back phenomenon, detection method, touch screen panel, and display device having touch screen panel embedded therein.

### SUMMARY OF THE INVENTION

An object of the present invention is to provide a touch signal detection apparatus and a touch signal detection method capable of preventing signal interference between a plurality of touch pads 10 when the touch pads 10 detect touch signals.

As described above, a characteristic configuration of present invention is as follows for achieving the above objects of the present invention and specific effects of the present invention.

According to an exemplary embodiment of the present invention, there is provided a touch signal detection apparatus disposed on an upper surface of a display device and sensing a touch capacitance generated by an approach of a touch input means as a human finger or a conductor similar thereto to detect whether a touch is performed, the touch signal detection apparatus including: a touch detection unit determining whether the conductor performs a touch by detecting touch signals received through a plurality of touch signal lines connected to each touch pad to transfer the touch signals, in which the touch detection unit may sequentially detect the touch signals in a column unit of the touch pad and divide each column of the touch pad into at least one sensing pad and a plurality of non-sensing pad when the touch signal is detected.

The sensing pad may be a touch pad detecting the touch signals by the touch detection unit and the non-sensing pad may be a touch pad not detecting the touch signals by the touch detection unit.

The non-sensing pad may be connected to a zero voltage, a ground voltage, or a constant DC voltage.

Positions of rows of the at least one sensing pad may be different every column upon detecting the touch signal.

The positions of the rows of the at least one sensing pad may be the same every column upon detecting the touch signal.

When the positions of the rows of the at least one sensing pad are same every column, a separation signal line having the zero voltage, the ground voltage, or the DC voltage may be disposed between the sensing pads.

The plurality of non-sensing pads may be positioned between the at least one sensing pads.

The non-sensing pad may be connected to the zero voltage, the ground voltage, or the DC voltage.

The sensing pad may be one per each column and the rest sensing pads may be the non-sensing pads.

The non-sensing pad may be connected to the zero voltage, the ground voltage, or the constant DC voltage.

All non-sensing pads are connected to have the same voltage.

The touch signal detection apparatus may further include: a charging means charging a parasitic capacitance Cp and a driving capacitance Cdry present in the touch pad and a touch capacitance Ct formed between the touch pad and a touch input tool; an alternating voltage applying unit applying an alternating voltage to the touch pad; and a level shift detection unit comparing a voltage variation at the touch detection sensor when the touch is not performed with the voltage variation at the touch detection sensor when the touch is performed to determine whether the touch is performed.

The charging means may be turned off after the completion of the charging to apply the alternating voltage in a state in which the parasitic capacitance Cp, the driving capacitance Cdrv, and the touch capacitance Ct are maintained in a floating state.

An input terminal of the level shift detection unit may maintain a high impedance (Hi-Z) state upon the determination on whether the touch is performed.

A voltage level fluctuation at the touch pad when the touch is performed may have a value smaller than the voltage level fluctuation when the touch is not performed.

The voltage fluctuation at the touch pad when the touch is performed and the voltage fluctuation at the touch pad when the touch is performed may be generated by being linked with a rising edge and a falling edge of the applied alternating voltage.

According to another exemplary embodiment of the present invention, there is provided a touch signal detection apparatus detecting whether a touch is performed at a plurality of touch pads arranged in a matrix form, including: a plurality of multiplexers receiving touch signals through a plurality of touch signal lines connected to a plurality of touch pads of each column to transfer the touch signals generated from the touch pads; a selection signal generator generating at least one selection signal for selecting one of the touch signals received by the multiplexers; and a touch detection unit detecting the touch signal selected by the selection signal to determine whether the touch is performed.

The at least one multiplexer used in the touch signal detection apparatus may have all the configurations of inputs and an outputs and have the same number of outputs and the same number of sensing signals and the same order of input signals selected for any selection signal.

The number of touch signals accommodated in each of the multiplexers may be the same as the number of touch pads of each column.

The touch signal lines input to each of the multiplexers may be disposed having directivity depending on positions of the touch pads of each column.

The directivity may represent that as a number for rows of the touch pads of each column is increased, a number for input pins of the touch signal lines input to each of the multiplexers is increased or as a number for rows of the touch pads of each column is reduced, a number for the input pins of the touch signal lines input to each of the multiplexers is reduced.

Each of the multiplexers may be configured to receive the touch signals through the touch signal lines connected to the touch pads belonging to the same column and not to receive the inputs from the touch signal lines connected to the touch pads belonging to other columns.

The selection signals generated from the selection signal generator may be commonly applied to each of the multiplexers.

The selection signal may be configured to send out only one output of the inputs of the multiplexers.

The touch pad corresponding to the one output selected by the selection signal may be a sensing pad and determine whether a touch is performed by the touch detection unit and the rest touch pads other than the sensing pad may be a non-sensing pad and may be connected to a zero voltage, a ground voltage, or a DC voltage.

The touch signal detection apparatus may further include: a charging mans charging a parasitic capacitance Cp and a driving capacitance Cdry present in the touch pad and a touch capacitance Ct formed between the touch pad and a touch input tool; an alternating voltage applying unit applying an alternating voltage to the touch pad; and a level shift detection unit comparing a voltage variation at the touch detection sensor when the touch is not performed with the voltage variation at the touch detection sensor when the touch is performed to determine whether the touch is performed.

The charging means may be turned off after the completion of the charging to apply the alternating voltage in a state in which the parasitic capacitance Cp, the driving capacitance Cdrv, and the touch capacitance Ct are maintained in a floating state.

An input terminal of the level shift detection unit may maintain a high impedance (Hi-Z) state upon the determination on whether the touch is performed.

A voltage level fluctuation at the touch pad when the touch is performed may have a value smaller than the voltage level fluctuation when the touch is not performed.

The voltage fluctuation at the touch pad when the touch is performed and the voltage fluctuation at the touch pad when the touch is not performed may be generated by being linked with a rising edge and a falling edge of the applied alternating voltage.

According to another exemplary embodiment of the present invention, there is provided a touch signal detection method detecting whether a touch is performed at a plurality of touch pads arranged in a matrix form, the touch signal detection method including: a touch detecting step of determining a touch of a conductor by detecting touch signals received through a plurality of touch signal lines connected to each of the touch pads to transfer the touch signals by a touch detection unit, in which in the touch detecting step, the touch signals may be sequentially detected in a column unit of the touch pad and each column of the touch pad may be divided into at least one sensing pad and a plurality of non-sensing pads upon the detection of the touch signal.

The touch detecting step may include: a step of charging, by a charging means, a parasitic capacitance Cp and a driving capacitance Cdry present in the touch pad and a touch capacitance Ct formed between the touch pad and a touch input tool; a step of applying, by an alternating voltage applying unit, an alternating voltage to the touch pad; and a level shift detecting step of comparing, by a level shift detection unit, a voltage variation at the touch detection sensor when the touch is not performed with the voltage variation at the touch detection sensor when the touch is performed to determine whether the touch is performed.

The charging means may be turned off after the completion of the charging to apply the alternating voltage in a state in which the parasitic capacitance Cp, the driving capacitance Cdrv, and the touch capacitance Ct are maintained in a floating state.

### BRIEF DESCRIPTION OF THE DRAWINGS

FIG. 1 is a perspective view illustrating an example of the existing touch screen panel.

FIG. 2 is a plan configuration diagram illustrating another example of the existing touch screen panel.

FIG. 3 is a cross-sectional view illustrating an example in which the touch screen panel of the FIG. 2 is installed on a display device.

FIG. 4 is an equivalent circuit diagram detecting a touch capacitance in FIG. 3.

FIG. 5 is a diagram illustrating an embodiment of a method for reducing a common voltage Vcom in the touch screen panel.

FIG. 6 is a diagram illustrating an embodiment of a case in which an interference of the touch signals occurs when two adjacent touch pads simultaneously detect the touch signals.

FIG. 7 is a block diagram for describing a configuration of a touch signal detection apparatus 200 according to an exemplary embodiment of the present invention.

FIG. 8 is a diagram illustrating an embodiment in which an interference problem due to a parasitic capacitance between adjacent sensor signal lines is solved, according to an exemplary embodiment of the present invention.

FIG. 9 is a diagram illustrating an embodiment in which the problem that a width of a sensor signal line is wide is solved, according to an exemplary embodiment of the present invention.

FIG. 10 is a diagram illustrating an embodiment in which a multiplexer according to an embodiment of the present invention is used.

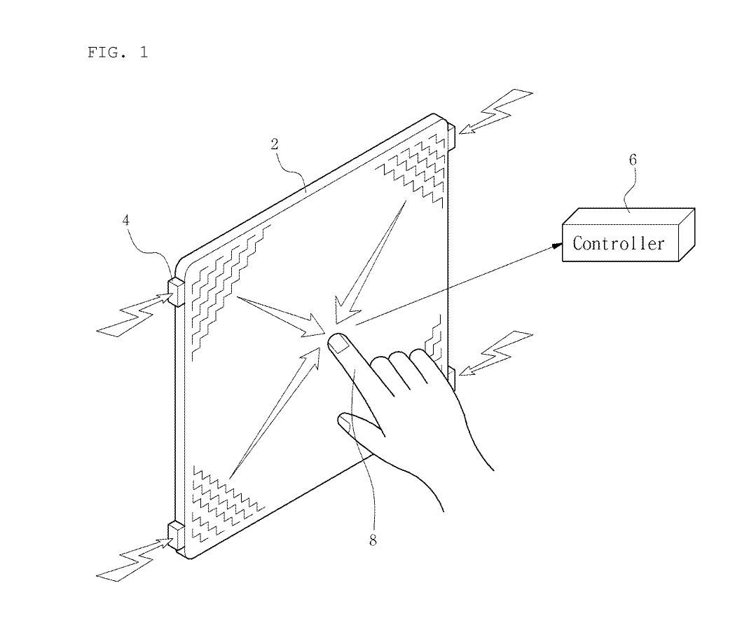

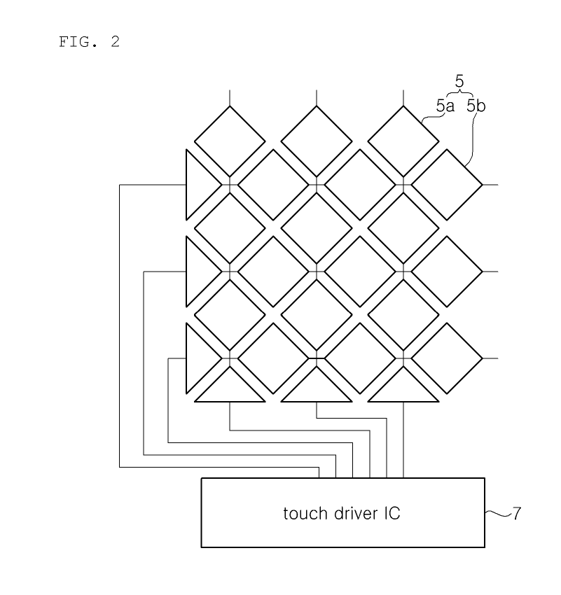

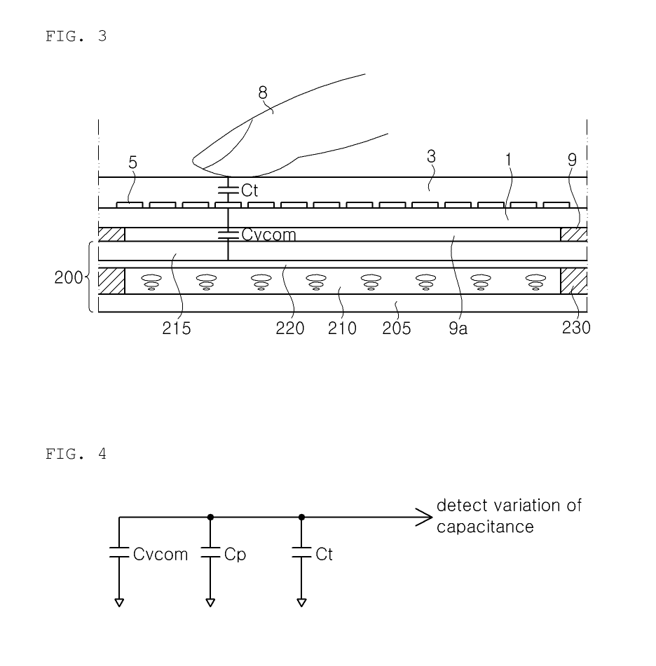

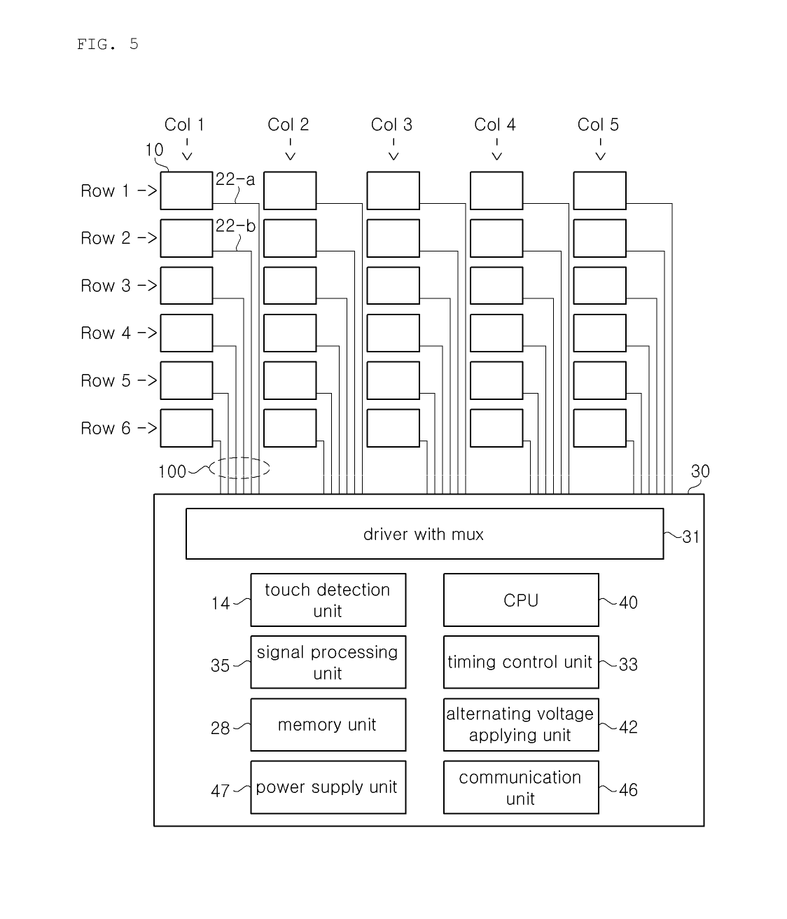

### DETAILED DESCRIPTION OF THE ILLUSTRATED EMBODIMENTS

Hereinafter, exemplary embodiments of the present invention will be described in detail with reference to the accompanying drawings.

In order to sufficiently understand the present invention, operational advantages of the present invention, and objects accomplished by exemplary embodiments of the present invention, the accompanying drawings showing exemplary embodiments of the present invention and contents described in the accompanying drawings should be referred.

Hereinafter, exemplary embodiments of the present invention will be described in detail with reference to the accompanying drawings. Like reference numerals proposed in each drawing denote like components.

A display device described in the present invention means any one of LCD, PDP, and OLED and means all means displaying other images.

Among the display devices listed above, the LCD requires a common voltage Vcom to drive a liquid crystal. For example, a small and medium portable LCD uses a line inversion scheme in which a common voltage of a common electrode alternates in one line or each of the plurality of gate lines, to thereby reduce current consumption. As another example, a large LCD uses a dot inversion driving scheme in which a common voltage of a common electrode has a constant DC level. As another example, an in-plane switching mode LCD displays an image by the line inversion scheme or the dot inversion driving scheme in which the common electrode is formed in a part of an area of a TFT substrate configuring the LCD. In the case of the in-plane switching mode LCD, a back ground is commonly formed over the whole of a color filter exposed to the outside through a back indium tin oxide (ITO) and is grounded to a ground signal to cut off electrostatic discharge (ESD).

According to the exemplary embodiment of the present invention, in addition to the electrode to which the common voltage Vcom is applied, all electrodes commonly acting within the display device are referred to as the “common electrode” and an alternating voltage or a DC voltage applied to the common electrode of the display device or a voltage alternating at a unspecific frequency is referred to as the “common voltage”.

The present invention detects a non-contact touch input of a finger or a touch input means having electrical characteristics similar thereto. Here, the “non-contact touch input” means that the touch input means such as a finger performs the touch input in a state in which the touch input means is spaced apart from the touch pad at a predetermined distance by a substrate present between an input means and the touch pad. The touch input means may contact an outer surface of the substrate. However, even in this case, the touch input means and the touch pad maintain a non-contact state. Therefore, a touch behavior of the finger to the touch pad may be expressed by the term “approach” Meanwhile, since the finger comes into contact with the outer surface of the substrate, the touch behavior of the finger to the substrate may be expressed by the term “contact”. In the present specification, the “approach” and the “contact” are commonly used.

Further, components such as “˜unit” to be described below are a set of unit function elements performing specific functions. For example, an amplifier for any signal is a unit function element and a set of amplifiers or signal converters may be named a signal conversion unit. Further, the “˜unit” may be included in an upper-level component or another “˜unit” or may include lower-level components and “˜units”. Further, the “˜unit” itself may also have a standalone CPU.

In the drawings, to clearly represent layers and regions, a thickness or a region is exaggerated in the drawings for clarity. Like reference numerals designate like elements throughout the specification. It will be understood that when an element such as a layer, a region, a substrate is referred to as being “on” another element or an “upper surface”, it may be “directly on” another element or may have an intervening element present therebetween. In contrast, the meaning that an element is “directly on” another element is that there are no intervening elements therebetween.

Further, a “signal” described in the present specification is collectively referred to as a voltage or a current unless specially indicated.

Further, in the present specification, a “capacitance” represents a physical magnitude and is used as the same meaning as “static capacity”. Meanwhile, a “capacitor” is referred to as an element having a capacitance which is a physical magnitude.

In the present specification, sign C used as a sign of a capacitor is used as a sign representing a capacitor and represents a capacitance which is a magnitude of the capacitor. For example, C1 is a sign representing a capacitor and a capacitance which is the magnitude of the capacitor means C1.

Further, in the present specification, the meaning “forcing a signal” means that a level of a signal maintaining any state is changed. For example, the meaning that a signal is forced to an on/off control terminal of a switching element means that the existing low level voltage is changed to a high level.

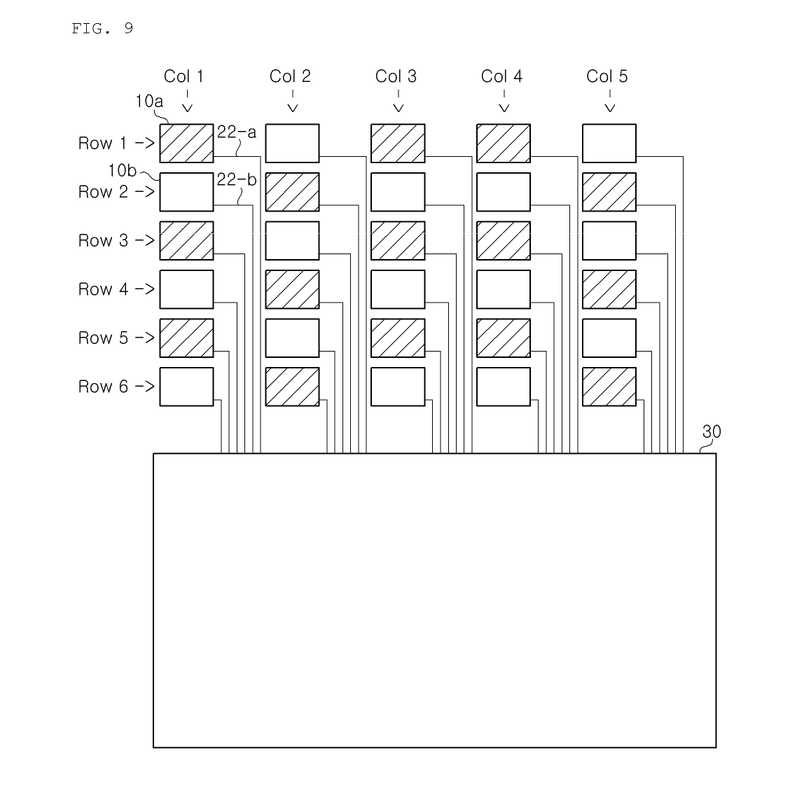

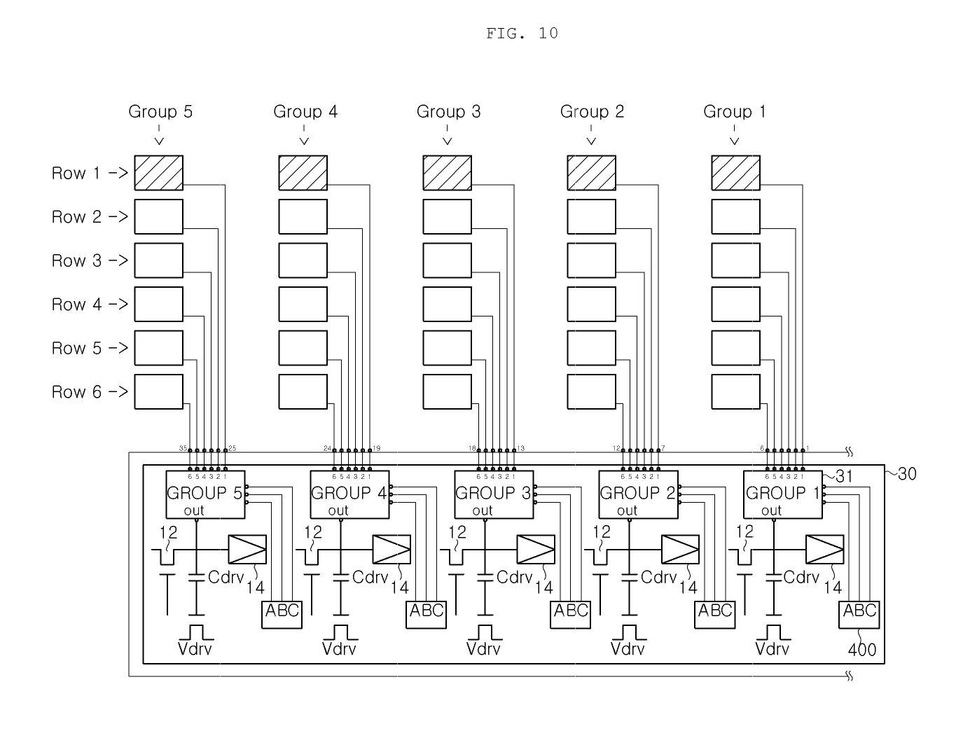

Further, in the present specification, a touch pad 10 is configured to include a sensing pad 10a (shaded touch pad of FIG. 9) and a non-sensing pad 10b (non-shaded touch pad of FIG. 9). The sensing pad 10a is the touch pad 10 (that is, touch pad simultaneously determining whether the touch is performed by the touch detection unit 14) connected to the touch detection unit 14 to detect touches and the non-sensing pad 10b is the touch pad 10 (that is, touch pad not simultaneously determining whether the touch performed upon the determination on whether the touch is performed by the sensing pad) that does not perform touch detection and is not connected to the touch detection unit 14. If the sensing pad 10a becomes the non-sensing pad 10b after completing the touch detection, any non-sensing pad 10b is switched to the sensing pad 10a in a predefined order. Therefore, the sensing pads and the non-sensing pads are not fixed and are sequentially determined in the predefined order. A time sharing technique is an embodiment defining an order. The non-sensing pad 10b may be connected to a DC power supply having a zero voltage, a ground voltage, or a DC voltage having a predetermined magnitude.

Further, in the present specification, detecting a touch or a touch signal has the same meaning and means detecting a difference between a voltage detected by a touch detection unit when a conductor such as a finger does not contact or approach the touch pad 10 and thus a touch capacitance is not formed and a voltage detected by the touch detection unit based on a touch capacitance Ct formed when the conductor such as a finger is opposite to the touch pad.

Further, in the present specification, a touch drive IC is short for TDI.

Further, in the present specification, a precharge and charging and a precharge voltage and a charging voltage are used as the same meaning.

Further, in the present specification, sensing pads and sensor signal lines connecting between the sensing pads are used as the same meaning unless specifically mentioned and non-sensing pads and non-sensing pad signal lines connecting between the non-sensing pads are used as the same meaning unless specifically mentioned.

Further, in the present specification, a column is a direction in which the sensor signal lines are formed in a group and then are toward a TDI 30 and a row is a direction perpendicular to a column direction.

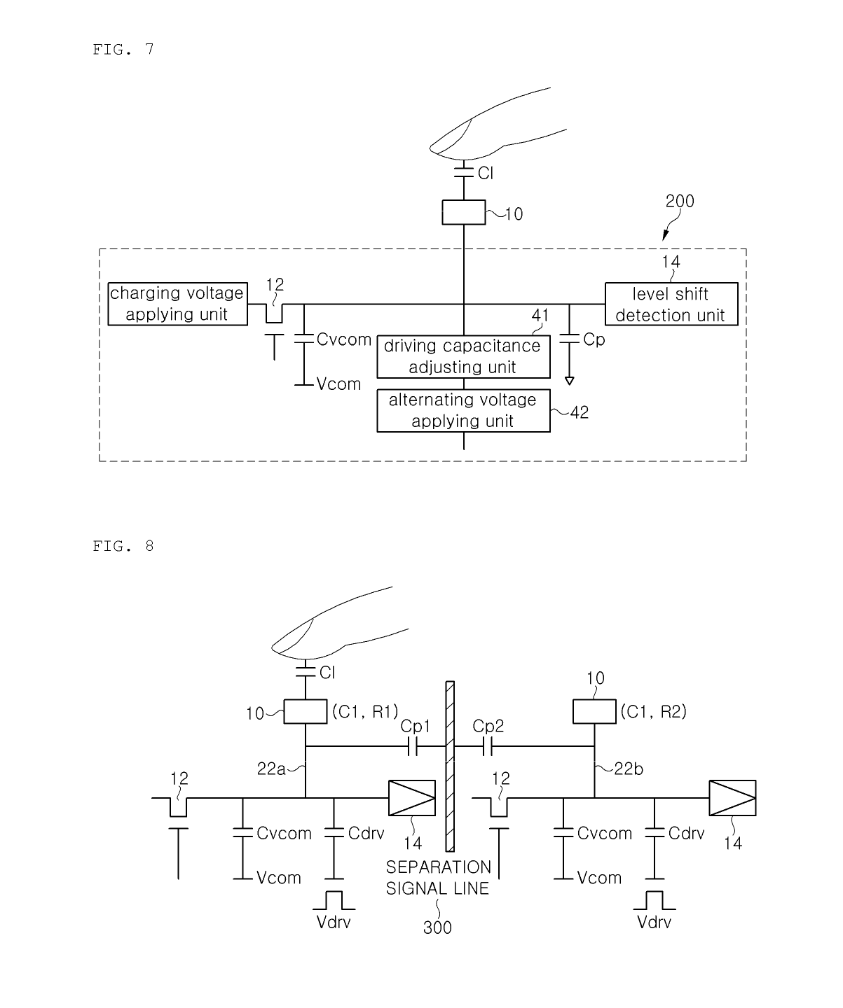

FIG. 7 is a block diagram for describing a configuration of a touch signal detection apparatus 200 according to an exemplary embodiment of the present invention. The touch signal detection apparatus 200 according to an exemplary embodiment of the present invention includes the touch pad 10, a driving capacitance adjusting unit 41, an alternating voltage applying unit 42, a charging voltage applying unit, and a level shift detection unit 14 (corresponding to the touch detection unit 14 in FIG. 5).

First, a touch detection operation of the level shift detection unit 14 will be described. The touch pad 10 is an electrode patterned on a substrate to detect a touch input and forms a touch capacitance Ct in a finger or a touch input tool such as a conductor. The touch pad 10 may be formed of a transparent conductor.

For example, the touch pad 10 may be made of transparent materials such as indium tin oxide (ITO), antimony tin oxide (ATO), carbon nano tube (CNT), and indium zinc oxide (IZO). However, as another example, the touch pad 10 may be made of metal.

The touch pad 10 outputs a signal depending on a touched state in response to an alternating voltage in a floating state after charges are charged. For example, the touch pad 10 responds to an alternating voltage Vdry alternating at a predetermined frequency to output different level shift values when being touched or not being touched by the touch input tool. The touch signal detection apparatus 200 may further include a charging means 12.

The charging means 12 may be a three-terminal type switching element performing a switching operation in response to a control signal supplied to an on/off control terminal or a linear element such as an OP-AMP supplying a signal in response to the control signal. An output terminal of the charging means 12 is connected to a touch capacitance Ct, a parasitic capacitance Cp, and a driving capacitance Cdry that are applied to the touch pad 10 and the charging means 12 is charged with the Ct, the Cdrv, the Cp, etc., when an input terminal of the charging means 12 is applied with any charging voltage in the state in which the charging means is turned on. Next, when the charging means 12 is turned off, signals charged in the Ct, the Cdrv, etc., are isolated in the changed state unless being separately discharged. In this case, to stably isolate the charged signals, an input terminal of the level shift detection unit to be described below preferably has high impedance. However, when the touch input is observed while the signal charged in the Cdrv, etc., is discharged or when the charged signals are isolated by other means or the touch input may be rapidly observed at discharge starting timing, the input terminal of the level shift detection unit may be enough to have low impedance.

The charges charged in the touch pad 10 by a turn on of the foregoing charging means 12 are isolated depending on a turn off of the charging means 12. The isolated state is called a floating state. The charge of the charging signal isolated between the charging means 12 and the level shift detection unit has a voltage level varying by the alternating voltage applied from the outside to the driving capacitance. The voltage level is different when the touch is performed and when the touch is not performed. The level difference before and after the touch is performed is called a level shift.

The driving capacitance adjusting unit 41 adjusts the driving capacitance formed between the touch pads 10.

The alternating voltage applying unit 42 applies the alternating voltage. In detail, the alternating voltage applying unit applies the alternating voltage alternating at a predetermined frequency to the touch pad 10 to fluctuate a voltage of the touch pad 10.

The level shift detection unit detects the level shift generated by the alternating voltage Vdry in the floating state. In detail, the level shift detection unit measures a voltage variation at the touch pad 10 when the touch is not performed and a voltage variation at the touch pad 10 when the touch is performed to detect whether the level shift is generated. That is, the voltage of the touch pad 10 rises or falls by the applied alternating voltage Vdry and the voltage level fluctuation when the touch is performed has a value smaller than that when the touch is not performed. Therefore, the level shift detection unit compares voltage levels before and after the touch is performed to detect the level shift.

Further, the level shift detection unit 14 may acquire the touch signal based on the difference in the voltage variations at the touch pads 10 depending on the alternating voltage before and after the touch is performed.

The level shift detection unit may be configured of a combination of various elements or circuits. For example, the level shift detection unit may be configured of a combination of at least one of an amplification element amplifying a signal of an output terminal of the touch pad 10, an analogue to digital converter (ADC), a voltage to frequency converter (VFC), a flip-flop, a latch, a buffer, a transistor (TR), a thin film transistor (TFT), a comparator, a DAC, etc.

Here, terms used in FIG. 7 are defined as follows.

The touch capacitance Ct means a capacitance formed between the touch pad 10 and a touch input tool such as a finger. The parasitic capacitance Cp means a capacitance included in the touch pad 10 and may include any parasitic capacitance generated in the touch pad 10, between signal wirings, by a layout inside the TDI, etc.

The driving capacitance Cdry is a capacitance formed in a path through which the alternating voltage Vdry alternating at a predetermined frequency for each touch pad 10 is supplied and may be present inside the TDI and separately present outside the TDI.

The charging means 12 is a switch, for example, a CMOS. A gate of the CMOS may be applied with a control signal Vg and a source (or drain) thereof may be applied with a charging voltage. Another exemplary embodiment of the present invention may use other elements that may be switched, not the CMOS.

A first input unit of the level shift detection unit may include a voltage follower. The voltage follower may output the same signal as an input signal and the input terminal has high impedance (Hi-z) characteristics. The voltage follower may serve as a buffer.

The charging means 12 is turned on to supply the charging voltage, to thereby charge the driving capacitance Cdrv, the touch capacitance Ct, and the parasitic capacitance Cp. Next, if the charging means 12 is turned off, the input terminal of the voltage follower becomes the high impedance and therefore the charged charges are isolated to maintain the voltage of the touch pad 10, such that a voltage Vnt of the touch pad 10 may be constantly maintained. Next, if the voltage of the alternating voltage Vdry rises or falls, a voltage Vo level at the output terminal of the touch pad 10 rises or falls by being linked with the alternating voltage.

A voltage fluctuation ΔVnt at the touch pad 10 due to the Cdry when the touch is not performed depends on the following [Equation 1].

$$Δ {V}_{nt} = Vpre \pm ( Vh - Vl ) \frac{Cdrv}{Cdrv + Cvcom + Cp} \qquad [ Equation 1 ]$$

Since the Ct is added to the Cdry in parallel when the touch is performed, a voltage fluctuation ΔVtc at the touch pad 10 when the touch is performed depends on the following [Equation 2].

$$Δ {V}_{tc} = Vpre \pm ( Vh - Vl ) \frac{Cdrv}{Cdrv + Cvcom + Cp + Ct} \qquad [ Equation 2 ]$$

In the above Equation 2, ΔV represents the voltage variation at the touch pad 10, Vh represents the high level voltage of the alternating voltage, VI represents the low level voltage of the alternating voltage, Cdry represents the driving capacitance, Cp represents the parasitic capacitance, Ct represents the touch capacitance, and Vpre represents the charging voltage and a sign after the Vpre when the alternating voltage rises becomes “+” and a sign after the Vpre when the alternating voltage falls becomes “−”.

Reviewing the above [Equation 1] and [Equation 2], in the ΔVtc against the ΔVnt before the touch is performed, the touch capacitance Ct is added to a denominator and therefore the voltage difference occurs, such that the touch signal may be detected when the voltage fluctuations before and after the touch is performed, that is, the level shift is detected.

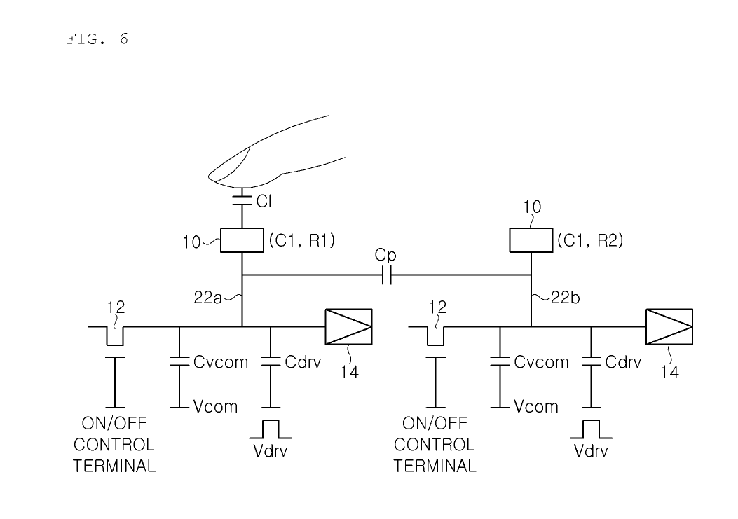

In the level shift detection method, when the touch signals at (C1, R1) and (C1, R2) of FIG. 5 are detected at the same time, the two touch pads are connected due to the parasitic capacitance Cp formed between the sensor signal lines as illustrated in FIG. 6 and thus the above [Equation 1] and [Equation 2] are changed, such that the error of the touch detection occurs.

Referring to FIG. 8, an embodiment of a method for solving the occurrence of the touch signal detection failure due to the parasitic capacitance present between the sensor signal lines 22 when the touch pad 10 and the sensor signal lines 22 are adjacent to each other puts a separate signal line (separation signal line 300) having a ground voltage, a zero voltage, or DC voltage having a predetermined magnitude between the adjacent sensor signal lines and the touch pad. That is, the separate signal line (separation signal line 300) is put between the touch pads 10 of the (C1, R1) and the (C1, R2) of FIG. 5 or the separate signal line (separation signal line 300) is put between the sensor signal lines 22 connected thereto. As a result, the parasitic capacitance Cp of FIG. 6 formed between the adjacent sensor signal lines 22 is separated into two parasitic capacitances Cp1 and Cp2 by the separate signal line (separation signal line 300) and a mutual interference is ruled out.

However, the method inserts the separate signal line (separation signal line 300) between all the sensor signal lines 22, and therefore there is problem in that a width of paths in which the sensor signal lines 22 are disposed may be wide. That is, referring to FIG. 5, there is a problem in that a width of places through which a group 100 of the sensor signal lines 22 passes may be wide.

FIG. 9 is an embodiment for solving the above problem. Referring to FIG. 9, a shaded touch pad 10 of FIG. 9 is a sensing pad 10a detecting a touch signal and a non-shaded touch pad 10 is a non-sensing pad 10b not detecting a touch. The non-sensing pad 10b is positioned between the sensing pads 10a and is a zero voltage, a ground voltage, or a DC voltage having a predetermined magnitude. That is, at timing when the sensing pad 10a detects the touch signal, the non-sensing pad 10b is positioned between the sensing pads 10a and the voltage of the non-sensing pad 10b is the zero voltage, the ground voltage, or the DC voltage. The TDI 30 performs a control so that the non-sensing pad 10b is connected to the zero voltage, the ground voltage, or the DC voltage. In this case, like col1 and col2, the sensing pads 10a may be disposed to cross each other or like col3 and col4, the touch signal may be detected at the same row. Like col3 and col4, when the touch signal is detected at the same row, the interference occurs between (C3, R1) and (C4, R1). As a result, as illustrated, it is preferable to dispose a DC line having the zero voltage, the ground voltage, or the DC voltage therebetween.

As illustrated in FIG. 9, when too many touch pads 10 detect the touch signal using an ADC, it takes predetermined time to detect the touch signal, and therefore the touch signal may be lost. Of course, it is possible to fast detect the touch signal by increasing the number of ADCs. However, there is a disadvantage in that when the number of ADCs is increased, a volume of the TDI 30 may be increased and the current consumption may be increased.

To solve the above problem, according to the exemplary embodiment, one sensing pad 10a is disposed in one column. Even in this case, the voltage of the non-sensing pad 10b is the zero voltage/ground voltage/DC voltage. Further, the voltage of the non-sensing pad is the same. That is, all the voltages of the non-sensing pads 10b present in the same column are the zero voltage, the ground voltage, or the DC voltage.

One of the methods for extracting one sensing pad 10a from a plurality of touch pads included in one column uses one multiplexer (hereinafter, referred to as mux). FIG. 10 illustrates an embodiment of the use of the multiplexer. The embodiment of FIG. 10 describes an example in which five groups each include six touch pads 10, which is an embodiment for explanation. Actually, more groups may be present and more touch pads 10 may be added even in these groups.

In the embodiment of FIG. 10, the group is a set of the touch pads 10 sharing a multiplexer 31. The multiplexer 31 is a 6 in ×1 out type of outputting one signal for six inputs. In the actual use example, the multiplexer may select various embodiments like a case of 20 in×1 out (select one of 20 inputs) or a case of 30 in×1 out (select one of 30 inputs).

To select one of several signals input to the multiplexer 31, a select control is required. To select one of the four input signals, two select signals are required and to select one of eight input signals, three select signals are required. In the embodiment of FIG. 10, one output signal of the six input signals is determined and therefore at least three selection signals are required, which is represented by “A, B, C”. If all the selection signals are commonly applied to the multiplexer 31, even if there is only a selection signal generator 400, the selection signal generator 400 is commonly applied to all the multiplexers and therefore a circuit for the selection signal generator is simple and the TDI 30 is also simple. Therefore, according to the present invention, the selection signal generated from one selection signal generator is commonly applied to all the multiplexers.

Further, for simplification of a circuit, the multiplexer 31 preferably uses the same type. The same type of multiplexer means the case in which 1) the number of inputs is the same, 2) the number of outputs is the same, 3) the number of selection signals is the same, and 4) an order of the input signals selected for any selection signal is the same. (That is, this means that when ABC is HLL, a fourth signal of the six signals input to the mux is selected and the fourth signal is output). For this purpose, all the multiplexers use the same selection signal.

All the multiplexers according to the present invention are the same type, and therefore a method for connecting the touch pad 10 to the multiplexer in a group connected to the multiplexer 31 is also the same. Referring again to FIG. 10, Row 1 is allocated to all No. 1 inputs of a multiplexer 30a and Row 2 is allocated to all No. 2 inputs of the multiplexer. Row 6 which is final is allocated to No. 6 input of the multiplexer. The wiring method is the same in all the multiplexers. The present invention uses a plurality of multiplexers and uses the same selection signal, such that one multiplexer selects one input signal. Therefore, except for the case in which a re-map method is not used, the touch pad 10 that is present in the same row is used to detect the touch signal. In this case, all the rest touch pads 10 other than the touch pads 10 present in the same row used to detect the touch are connected to the zero voltage, the ground voltage, or the predetermined DC voltage. Further, the voltage of the non-sensing pad 10b is the same zero voltage, the same ground voltage, or the same DC voltage.

Referring again to FIG. 10, one multiplexer is used in one group and therefore as an input pin of the TDI 30, the same number of pins is allocated to each group. For example, there are six touch pads 10 in five groups illustrated in FIG. 10, respectively, and therefore six connection pins are allocated to one group in the TDI 30. This means that the same number of pins such as Nos. 1 to 6, Nos. 7 to 12, etc., is allocated in FIG. 10.

Further, there is a group to which the pin having the same number of inputs is allocated in the TDI 30. Referring to FIG. 10, since Nos. 1 to 6 pins are group 1, Nos. 7 to 12 pins are group 2, and Nos. 25 to 30 pins are group 5, six pins are identically allocated to five groups. There may be a case in which several inputs are added to any group and thus the number of pins is increased. Even in this case, the same multiplexer may be used.

Further, the input pins is connected to the corresponding group in the TDI 30, that is, to the corresponding multiplexer in TDI 30. For example, signals of Nos. 7 to 30 pins of other groups may not be interposed among Nos. 1 to 6 input pins of the TDI in which the group 1 is disposed. This is a scheme for selecting the same input signal by the same selection signal to use the touch pads 10 of the same row for the touch signal detection so as to easily operate an ADC, an amplifier, etc., based on a rule. Therefore, a tendency to increase (or decrease) a Row number selected as the pin number in the TDI 30 for each group is increased (or decreased) is the same. That is, this means that the tendency to increase a row number selected as the pin number of the TDI is increased in the group 1 is identically applied to all the groups.

In this situation, since the row and column selected to detect the touch signal are regular, when the touch signals stored in memory units 28 one-to-one mapped to each touch pad 10 are read, it is possible to perform a required operation using the touch signal without any manipulation. (Required operation may extract touch coordinates). For example, if the touch signals are detected in (C3, R3) and (C3, R4), these touch signals are signals detected by two continued sensors and even in the memory unit 28, the touch signals are continuously stored in the corresponding memory and therefore it is possible to obtain touch coordinates even if the operation such as the re-map (process of re-mapping the touch signals stored in the memory unit to coincide with the map of the touch sensors) is not performed.

The touch signal detection method according to the present invention is to detect whether the touch is performed at the touch pad including the plurality of touch pads arranged in a matrix form.

The touch signal detection method according to the exemplary embodiment of the present invention includes a touch detecting step of detecting the touch signal received through the plurality of touch signal lines connected to each touch pad to transfer the touch signals to determine whether the conductor performs a touch and is performed by the touch detection unit or the level shift detection unit 14.

The touch pad further includes at least one separation signal line 300 having a predetermined constant width that is not connected to the touch pad between the respective rows of the touch pad and between the touch signal lines connected to the touch detection sensor of the corresponding row.

The separation signal line is connected to the zero voltage, the ground voltage, or the constant DC voltage.

In the touch detection step, the touch signals are sequentially detected in a column unit of the touch pad, in which each column of the touch pad is divided into at least one sensing pad upon the detection of the touch signal, the touch pad simultaneously determining whether the touch is performed by the touch detection unit, and the touch pad not determining whether the touch is performed upon determining whether to touch of the plurality of non-sensing pads and sensing pads.

The non-sensing pad is connected to the zero voltage, the ground voltage, or the constant DC voltage.

Upon detecting the touch signal, the positions of the rows of the sensing pad and the non-sensing pad may be different in each column or may be the same in each column.

The sensing pad in each column is plural and at least one non-sensing pad is positioned between the sensing pads.

The non-sensing pad is connected to the zero voltage, the ground voltage, or the constant DC voltage.

This is a method for more easily removing the interference between the signal lines than a method for removing the parasitic capacitance between the signal lines, having the separate separation signal line disposed therebetween.

That is, the non-sensing pad is disposed between the sensing pads and thus the non-sensing pad may serve as the separate separation signal line.

In detail, the non-sensing pad serves to separate between the sensing pads and the touch signal line connected to the non-sensing pad serves as the separation signal line separating the touch signal line connected to the sensing pad.

Therefore, there is no disadvantage in that the group of the signal lines is increased, thereby obtaining the preferred effect of removing the interference between the signal lines.

The sensing pad is one per each column, the rest sensing pads may be configured to become the non-sensing pad, and the non-sensing pad is connected to the zero voltage, the ground voltage, or the constant DC voltage.

In particular, all the non-sensing pads are connected to have the same voltage.

Further, the touch detection step will be described in more detail.

The touch detecting step includes: a step of charging, by the charging means, the parasitic capacitance Cp and the driving capacitance Cdry present in the touch pad and a touch capacitance Ct generated by the conductor; a step of applying, by the alternating voltage applying unit, the alternating voltage to the touch pad; and a level shift detecting step of comparing, by the level shift detection unit, the voltage variation at the touch detection sensor when the touch is not performed with the voltage variation at the touch detection sensor when the touch is performed to determine whether the touch is performed.

The charging means is turned off after the completion of the charging to apply the alternating voltage in a state in which the parasitic capacitance Cp, the driving capacitance Cdrv, and the touch capacitance Ct are maintained in a floating state and the input terminal of the level shift detection unit maintains the high impedance (Hi-Z) state upon the determination on whether the touch is performed.

The voltage variation at the touch detection sensor when the touch is performed is smaller than the voltage variation at the touch detection sensor when the touch is not performed and the voltage fluctuation at the touch detection sensor when the touch is performed and the voltage fluctuation at the touch detection sensor when the touch is not performed are generated by being linked with a rising edge and a falling edge of the applied alternating voltage.

As set forth above, according to the touch signal detection apparatus and the touch signal detection method according to the present invention, it is possible to improve the touch detection resolution by removing the interference between the touch signals even in the case of the multi touch.

According to the touch signal detection apparatus and the touch signal detection method according to the present invention, it is possible to easily detect the touch signals and minimize the effect on the display device to maximize the display quality of the display device.

The present invention is not limited to the above exemplary embodiments and therefore it is apparent to a person with ordinary skill in the art to which the present invention pertains that the exemplary embodiments of the present invention may be variously modified or changed without departing from the technical subjects of the present invention.

What is claimed is:

1. A touch signal detection apparatus disposed on an upper surface of a display device and sensing a touch capacitance generated by an approach of a touch input means as a human finger or a conductor similar thereto to detect whether a touch is performed, the touch signal detection apparatus comprising:
a touch detection unit determining whether the conductor performs a touch by detecting touch signals received through a plurality of touch signal lines connected to each touch pad to transfer the touch signals,
wherein the touch detection unit sequentially detects the touch signals in a column unit of the touch pad and divides each column of the touch pad into at least one sensing pad and a plurality of non-sensing pad when the touch signal is detected.

2. The touch signal detection apparatus of claim 1, wherein the sensing pad is a touch pad detecting the touch signals by the touch detection unit and the non-sensing pad is a touch pad not detecting the touch signals by the touch detection unit, and
wherein the non-sensing pad is connected to a zero voltage, a ground voltage, or a constant DC voltage.

3. The touch signal detection apparatus of claim 1, wherein positions of rows of the at least one sensing pad are different every column upon detecting the touch signal, and
wherein positions of rows of the at least one sensing pad are the same every column upon detecting the touch signal.

4. The touch signal detection apparatus of claim 1, wherein the plurality of non-sensing pads are positioned between the at least one sensing pads.

5. The touch signal detection apparatus of claim 1, wherein the sensing pad is one per each column and the rest touch pads are the non-sensing pads, and
wherein all non-sensing pads are connected to have the same voltage.

6. The touch signal detection apparatus of claim 1, further comprising:
a charging means charging a parasitic capacitance Cp and a driving capacitance Cdry present in the touch pad and a touch capacitance Ct formed between the touch pad and a touch input tool;
an alternating voltage applying unit applying an alternating voltage to the touch pad; and
a level shift detection unit comparing a voltage variation at a touch detection sensor when the touch is not performed with a voltage variation at the touch detection sensor when the touch is performed to determine whether the touch is performed.

7. The touch signal detection apparatus of claim 6, wherein the charging means is turned off after the completion of the charging to apply the alternating voltage in a state in which the parasitic capacitance Cp, the driving capacitance Cdrv, and the touch capacitance Ct are maintained in a floating state.

8. The touch signal detection apparatus of claim 7, wherein an input terminal of the level shift detection unit maintains a high impedance (Hi-Z) state upon the determination on whether the touch is performed.

9. The touch signal detection apparatus of claim 6, wherein a voltage level fluctuation at the touch pad when the touch is performed has a value smaller than a voltage level fluctuation when the touch is not performed.

10. The touch signal detection apparatus of claim 6, wherein the voltage fluctuation at the touch pad when the touch is performed and the voltage fluctuation at the touch pad when the touch is not performed are generated by being linked with a rising edge and a falling edge of the applied alternating voltage.

11. A touch signal detection apparatus detecting whether a touch is performed at a plurality of touch pads arranged in a matrix form, comprising:
a plurality of multiplexers receiving touch signals through a plurality of touch signal lines connected to a plurality of touch pads of each column to transfer the touch signals generated from the touch pads;
a selection signal generator generating at least one selection signal for selecting one of the touch signals received by the multiplexers; and
a touch detection unit detecting the touch signal selected by the selection signal to determine whether the touch is performed.

12. The touch signal detection apparatus of claim 11, wherein the touch signal lines input to each of the multiplexers are disposed having directivity depending on positions of the touch pads of each column.

13. The touch signal detection apparatus of claim 12, wherein the directivity represents that as a number for rows of the touch pads of each column is increased, a number for input pins of the touch signal lines input to each of the multiplexers is increased or as a number for rows of the touch pads of each column is reduced, a number for the input pins of the touch signal lines input to each of the multiplexers is reduced.

14. The touch signal detection apparatus of claim 13, wherein each of the multiplexers is configured to receive the touch signals through the touch signal lines connected to the touch pads belonging to the same column and not to receive inputs from the touch signal lines connected to the touch pads belonging to other columns.

15. The touch signal detection apparatus of claim 11, wherein the touch pad corresponding to the one output selected by the selection signal is a sensing pad and determines whether the touch is performed by the touch detection unit and the rest touch pads other than the sensing pad are a non-sensing pad and is connected to a zero voltage, a ground voltage, or a DC voltage.

16. The touch signal detection apparatus of claim 11, further comprising:
a charging means charging a parasitic capacitance Cp and a driving capacitance Cdry present in the touch pad and a touch capacitance Ct formed between the touch pad and a touch input tool;
an alternating voltage applying unit applying an alternating voltage to the touch pad; and
a level shift detection unit comparing a voltage variation at a touch detection sensor when the touch is not performed with a voltage variation at the touch detection sensor when the touch is performed to determine whether the touch is performed.

17. The touch signal detection apparatus of claim 16, wherein the charging means is turned off after the completion of the charging to apply the alternating voltage in a state in which the parasitic capacitance Cp, the driving capacitance Cdrv, and the touch capacitance Ct are maintained in a floating state.

18. A touch signal detection method detecting whether a touch is performed at a plurality of touch pads arranged in a matrix form, the touch signal detection method comprising:
a touch detecting step of determining whether a conductor performs a touch by detecting touch signals received through a plurality of touch signal lines connected to each of the touch pads to transfer the touch signals by a touch detection unit,
wherein in the touch detecting step, the touch signals are sequentially detected in a column unit of the touch pad and each column of the touch pad is divided into at least one sensing pad and a plurality of non-sensing pads upon the detection of the touch signal.

19. The touch signal detection method of claim 18, wherein the touch detecting step includes:
a step of charging, by a charging means, a parasitic capacitance Cp and a driving capacitance Cdry present in the touch pad and a touch capacitance Ct formed between the touch pad and a touch input tool;
a step of applying, by an alternating voltage applying unit, an alternating voltage to the touch pad; and
a level shift detecting step of comparing, by a level shift detection unit, a voltage variation at a touch detection sensor when the touch is not performed with a voltage variation at the touch detection sensor when the touch is performed to determine whether the touch is performed.

20. The touch signal detection method of claim 19, wherein
the charging means is turned off after the completion of the charging to apply the alternating voltage in a state in which the parasitic capacitance Cp, the driving capacitance Cdrv, and the touch capacitance Ct are maintained in a floating state.
